(19) United States
(12) Patent Application Publication
(10) Pub. No.: US 2024/0358010 A1
(43) Pub. Date: Oct. 31, 2024

(54) EQUINE SHOE AND METHOD

(71) Applicant: EasyCare, Inc., Durango, CO (US)

(72) Inventor: Garrett Ford, Durango, CO (US)

(73) Assignee: EasyCare, Inc., Durango, CO (US)

(21) Appl. No.: 18/649,562

(22) Filed: Apr. 29, 2024

Related U.S. Application Data
(60) Provisional application No. 63/462,458, filed on Apr. 27, 2023.

(51) Int. Cl. A01L 5/00; A01L 1/02

(52) U.S. Cl. CPC A01L 5/00; A01L 1/02

(57) ABSTRACT

An equine shoe including a platform and cuffs or lateral walls. The lateral wall of the platform has proximal and distal cut outs. The proximal and distal cutouts of the lateral wall allows for expansion and contraction of a horse hoof through phases a horses gait. The shoe allows for variable customization to cater to all types of horse hoof width and sizes. The lateral walls can either be a uniform material with the shoe platform or the lateral walls can be separate parts of the shoe to allow custom fixture to the horse hoof. The separate lateral walls can then be heat welded to the platform to create a uniform shoe. Alternatively a cuff can be glue to the horse hoof and be received by a corresponding shoe.

### REFERENCE TO RELATED APPLICATION

This application claims the benefit of and priority to U.S. provisional application No. 63/462,458, filed on Apr. 27, 2023, which is hereby incorporated by reference in its entirety.eee

### FIELD OF THE INVENTION

This patent application relates to equine shoes with improved fitment and durability.

### BACKGROUND

For centuries, metal horse shoes have been used to protect a horse hooves. More recently, modern shoes have been made with flexible materials that more fully protect horse hooves. Such modern shoes may include a sole with a flat top surface that meets the underside of the hoof and an upper that projects upward from the sole and forms a peripheral enclosure for at least part of the hoof of the horse. This enclosure is generally fixed in size, such that different-size hooves require different-size shoes. These shoes are fastened to the wall of the horse's hoof either mechanically, via a variety of fasteners (e.g., hook and loop style fasteners) attached to the upper that strap around the pastern or the wall portion of the hoof. One such modern equine shoe is described in U.S. Pat. No. 8,196,378, which is incorporated by reference herein in its entirety. In use, such shoes are installed by spreading open the sides of the upper, slipping the shoe onto the hoof from the front, and securing the shell on the hoof with the intended fastening means. Alternative modern equine shoes can have a shell and liner configuration, as described in U.S. Pat. No. 8,151,546, which is incorporated by reference herein in its entirety.

While modern horse shoes provide advantages over traditional metal shoes, both modern and traditional horse shoes suffer from a number of persistent and performance-limiting drawbacks. On the one hand, while traditional, metal shoes are made of a durable material, they present persistent challenges in sizing and attachment to a horse hoof, and in some instances impede healthy hoof growth, support and movement. On the other hand, modern polymer shoes, have a number of drawbacks of their own, including the less durable and less rigid/supportive nature of polymers. That is, modern shoes can be challenging to size and durably attach to a horse hoof, while also being prone to excessive wear and breakage.

What is needed, therefore, is an equine shoe that improves upon or resolves one or more of these drawbacks.

### SUMMARY

This application discloses an equine shoe with a horse shoe shaped, polymer upper portion. The upper has a top, a bottom, a proximal end, a distal end, and an outer periphery. One or more cuffs are attached to the outer periphery. The cuffs can be provided with distal and proximal cutouts. The upper is overmolded onto a metal lower, which is provided with a plurality of fenestrations and cavities. The lower can also be provided with treads for traction.

### BRIEF DESCRIPTION OF DRAWINGS

Embodiments of the application will be described in detail in conjunction with FIGS. 1-29.

FIG. 1 is a perspective view of the shoe according to the disclosure.

FIG. 2 is a perspective quarter side view of the shoe of FIG. 1.

FIG. 3 is a perspective side view of the shoe of FIG. 1.

FIG. 4 is a perspective rear view of the shoe of FIG. 1 according to the disclosure.

FIG. 5 is a perspective view of the shoe of FIG. 1 according to the disclosure.

FIG. 6 is side view of a portion of the shoe of FIG. 1.

FIG. 7 is a perspective view of a metal shoe according to the disclosure.

FIG. 8 is a side view of a metal shoe according to the disclosure.

FIG. 9 a perspective view of a metal shoe according to the disclosure.

FIG. 10 a perspective view of a metal shoe according to the disclosure.

FIG. 11 a front perspective view of a metal shoe according to the disclosure.

FIG. 12 a perspective view of a shoe according to the disclosure.

FIG. 13 a perspective view of a shoe according to the disclosure.

FIG. 14 a perspective view of a shoe according to the disclosure.

FIG. 15 a perspective view of a shoe according to the disclosure.

FIG. 16 a perspective view of a shoe according to the disclosure.

FIG. 17 a perspective bottom view of a shoe according to the disclosure.

FIG. 18 a perspective bottom view of a shoe according to the disclosure.

FIG. 19 a perspective rear view of a shoe according to the disclosure.

FIG. 20 is a rear view of a shoe according to the disclosure.

FIG. 21 is a side view a shoe according to the disclosure.

FIG. 22 a perspective top view of a shoe according to the disclosure.

FIG. 23 a perspective side view of a shoe according to the disclosure.

FIG. 24 is a perspective bottom view of a shoe according to the disclosure.

FIG. 25 is a perspective rear view of a shoe according to the disclosure.

FIG. 26 is a perspective rear view of a shoe according to the disclosure.

FIG. 27 is perspective a bottom view of a shoe according to the disclosure.

FIG. 28 is a perspective top view of a shoe according to the disclosure.

FIG. 29 is a perspective, partial front view of a shoe according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

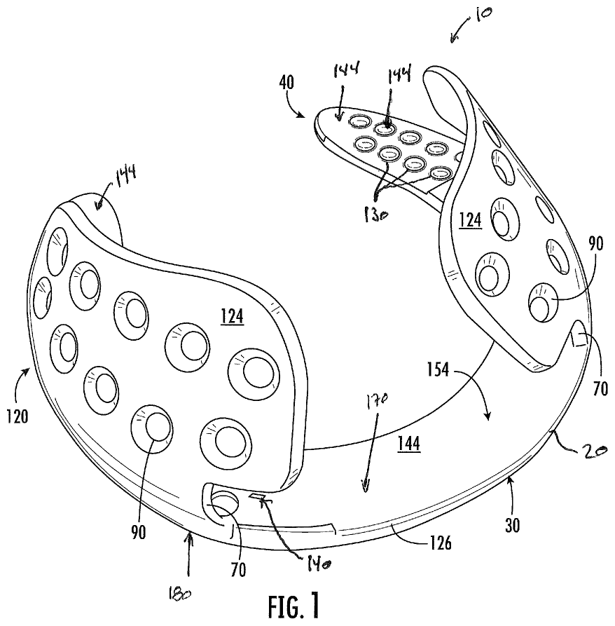

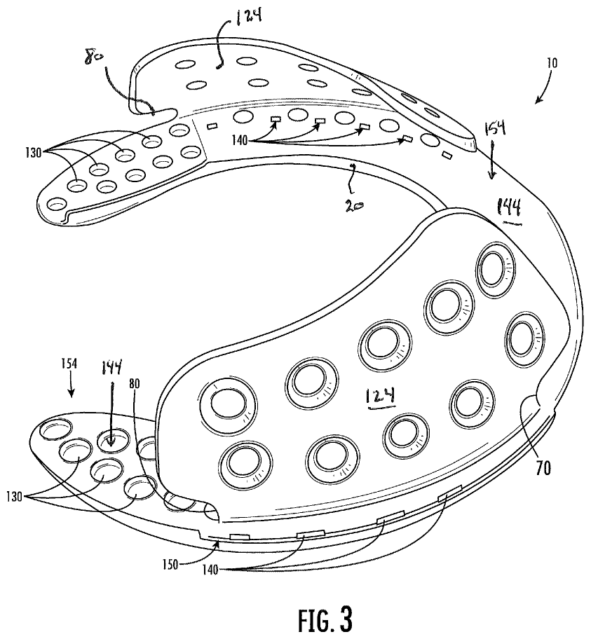

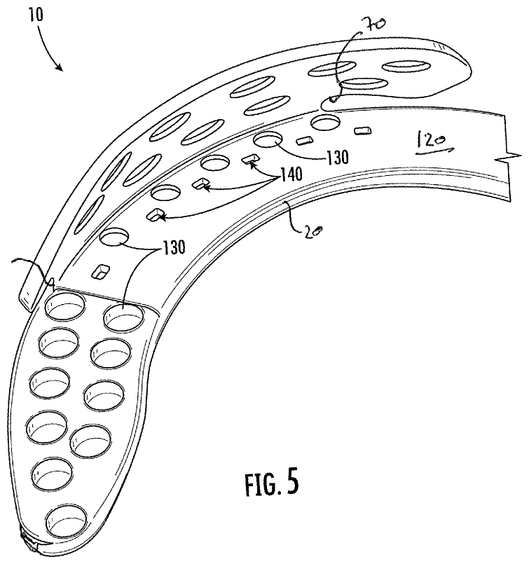

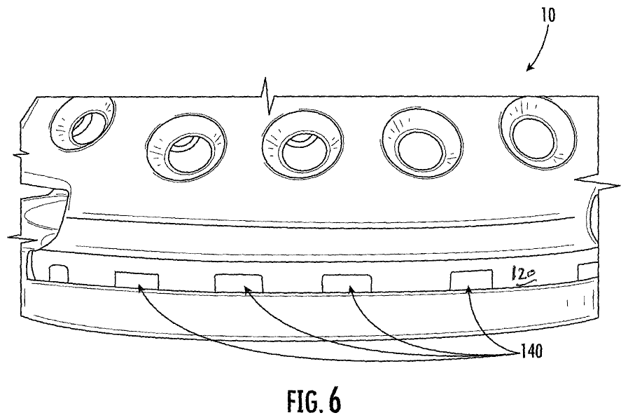

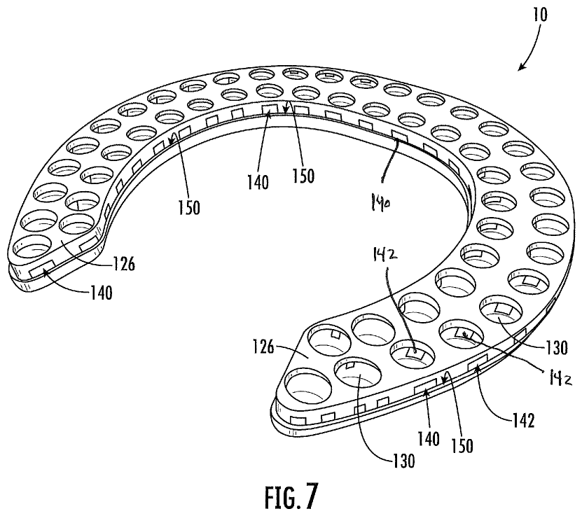

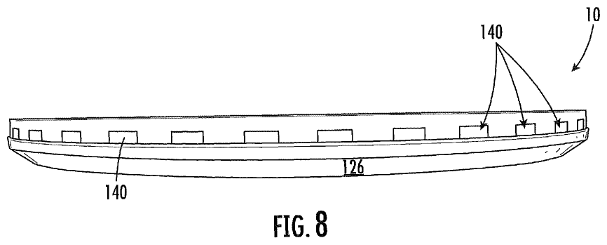

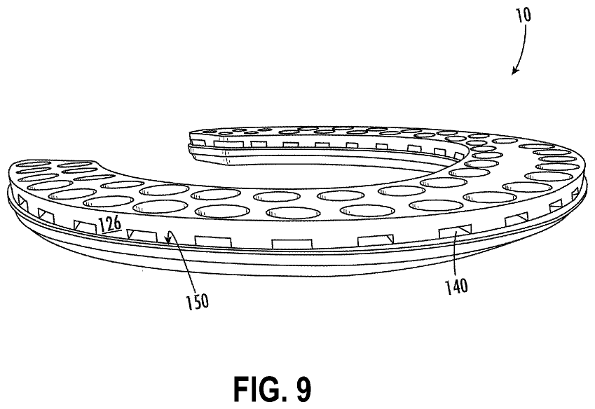

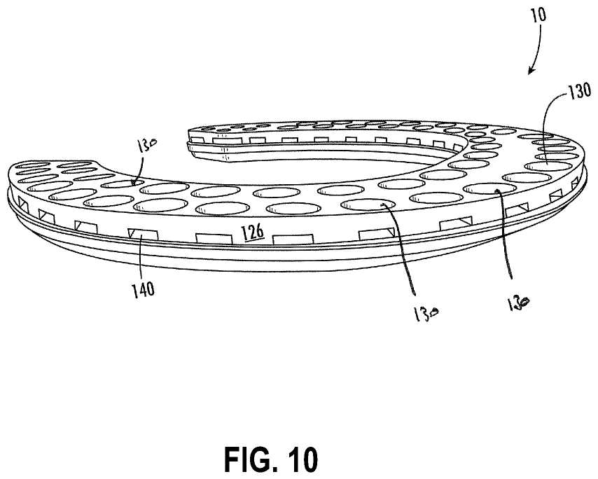

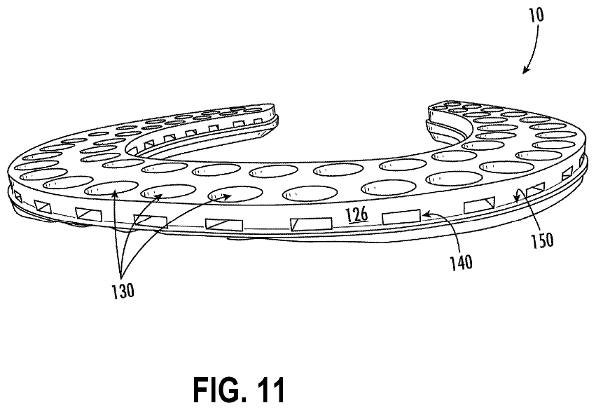

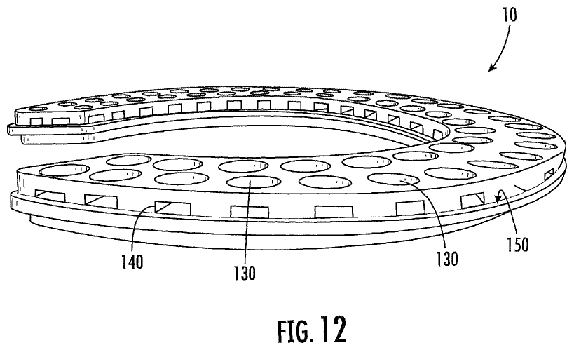

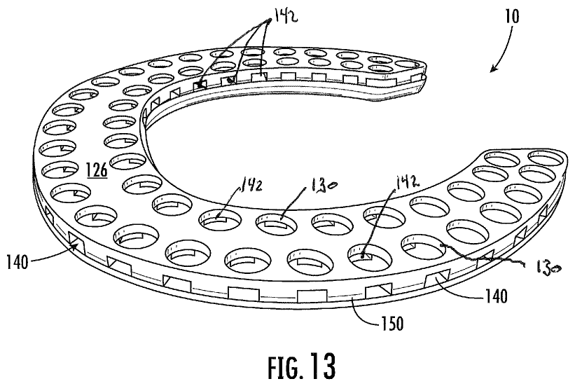

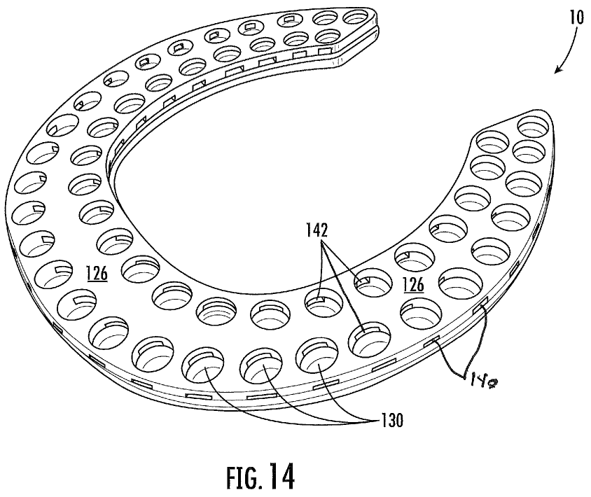

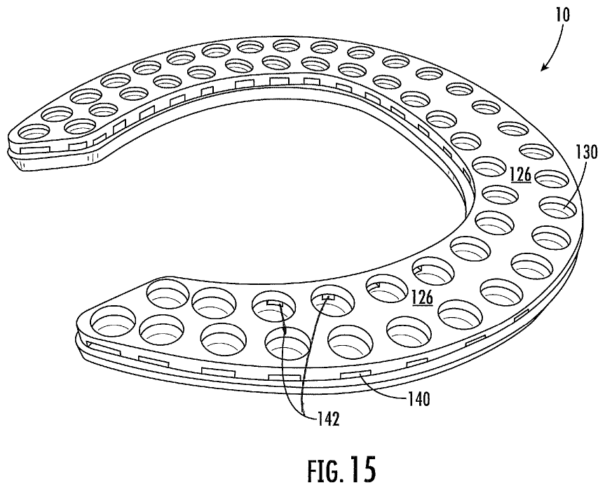

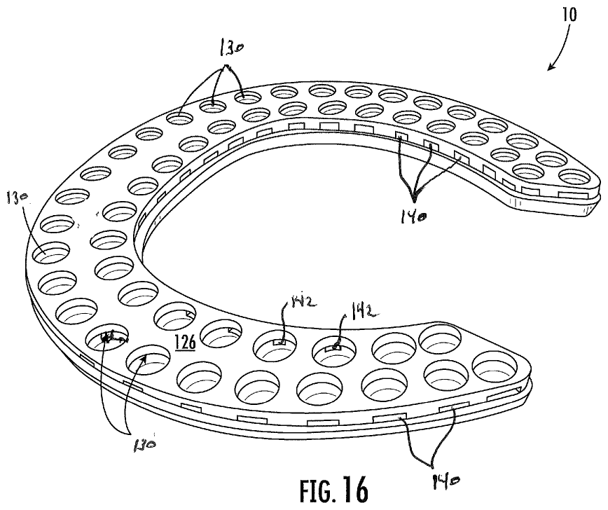

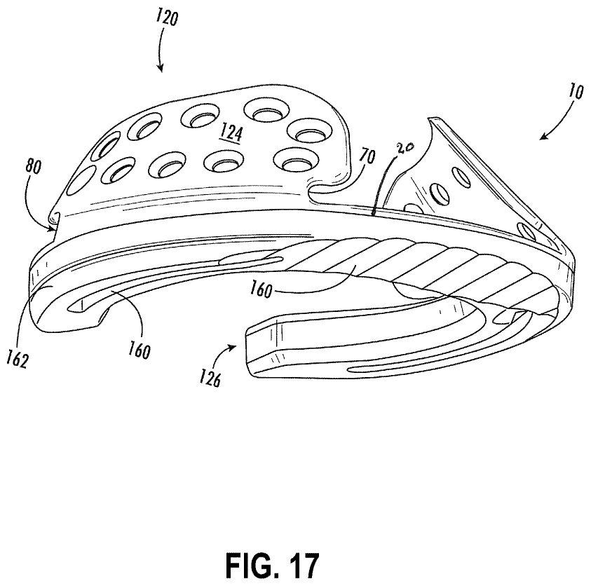

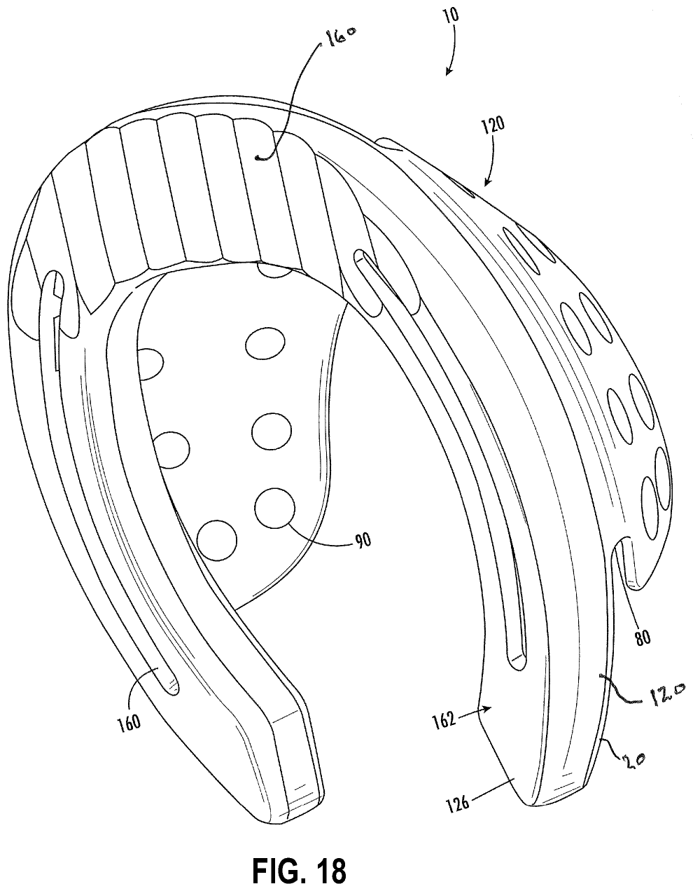

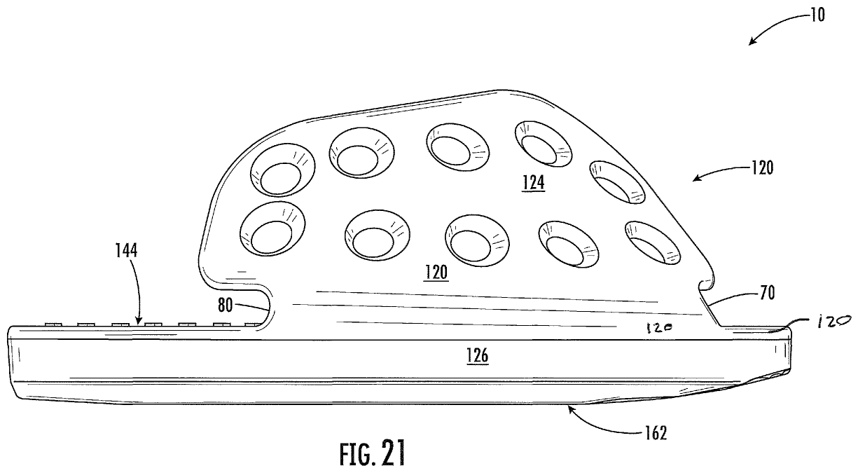

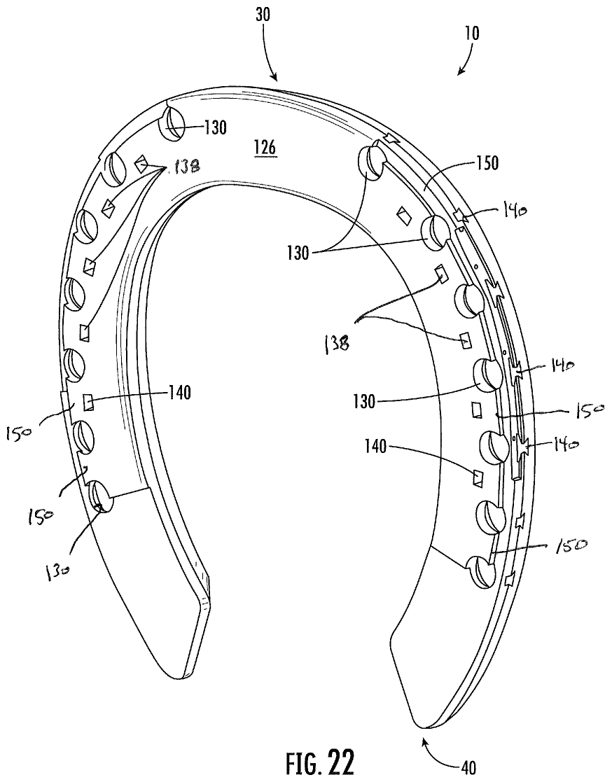

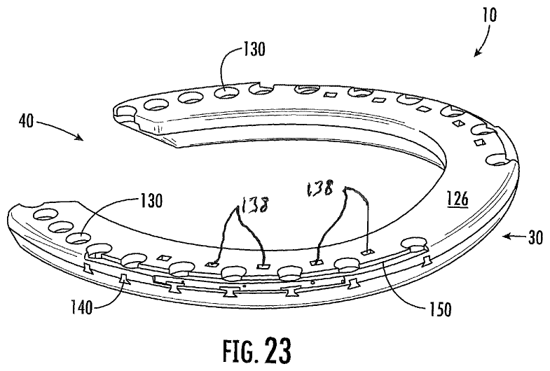

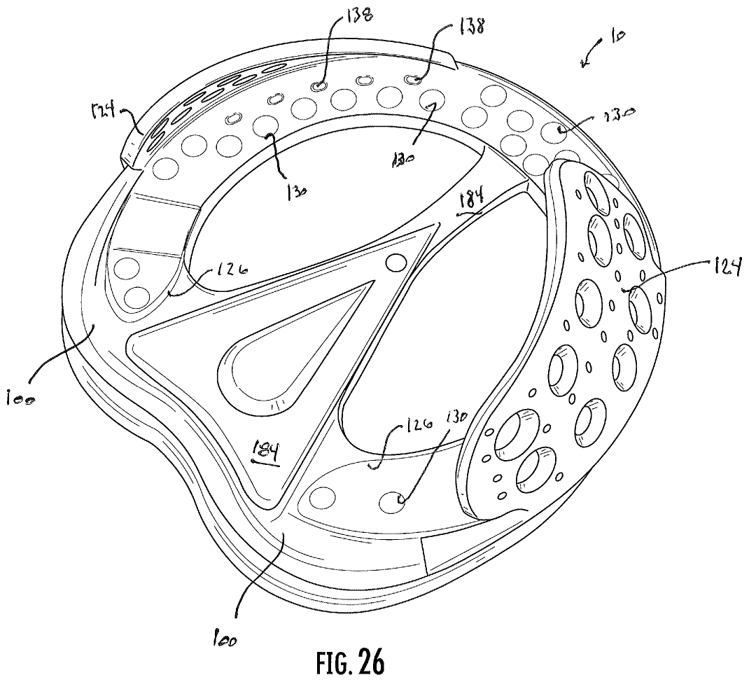

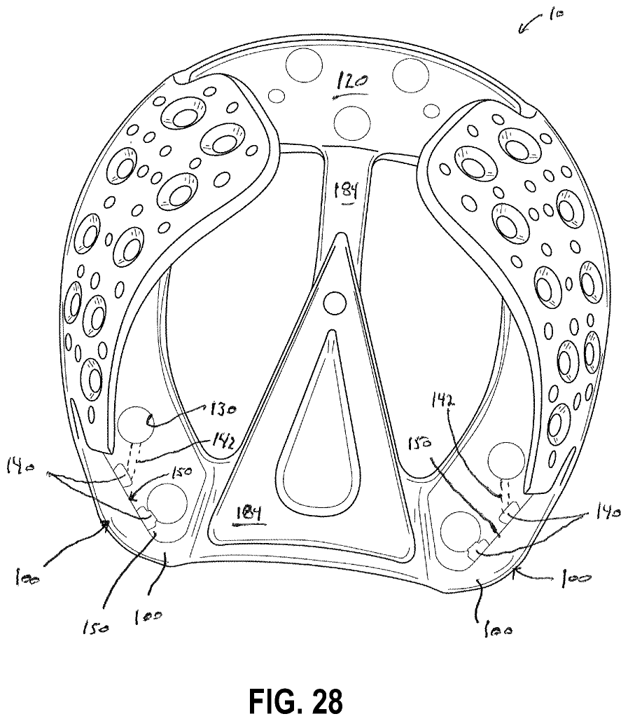

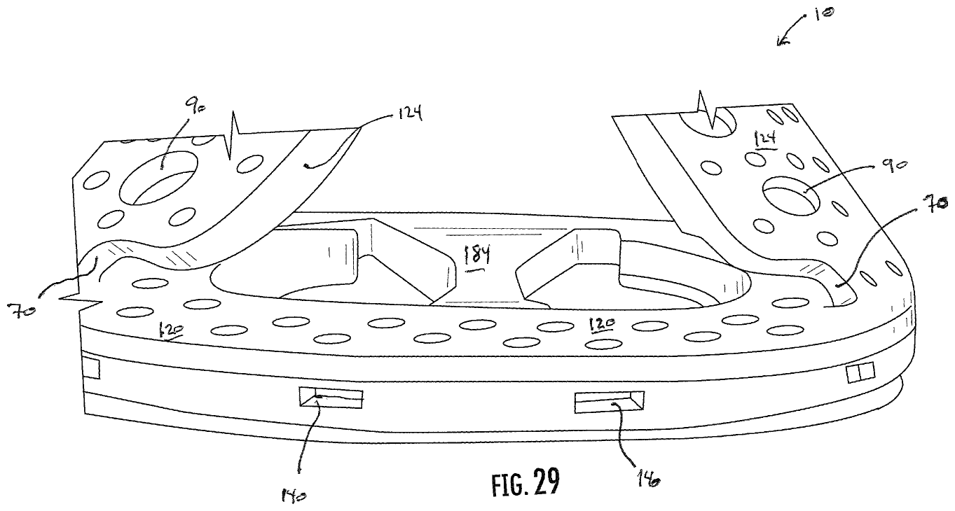

Embodiments of the present disclosure are best understood by referring to FIGS. 1-29 of the drawings, like numerals being used for like and corresponding parts of the various drawings.

### LIST OF REFERENCES

10 Shoe
20 Platform
30 Distal end
40 Proximal end
70 Distal cutout
80 Proximal cutout
90 Lateral wall holes
100 Heel Region
120 Polymer Upper
124 Cuff
126 Shoe
130 Cavity
138 Nail Hole
140 Fenestration
142 Passageway
144 Polymer Surface
150 Ridge
154 Upper surface
160 Tread
162 Bottom
170 Superior end
180 Inferior end
184 Caudal Support

In general, shoe 10 has a platform 20 with a proximal end 40, a distal end 30, and cuffs or lateral walls 124 that extend from the platform. Shoe 10 includes a polymer upper 120 secured to metal shoe 126. In particular, polymer upper 120 is overmolded to metal shoe 126 such that the polymer is permanently and stably attached to metal shoe 126. Metal shoe 126 includes a series of cavities 130 and fenestrations 140. Cavities 130 and fenestrations 140 can be interconnected by one or more passageways 142. Further, fenestrations 140 include lateral openings that are filled or encapsulated by the polymer material of polymer upper 120. Cuffs or lateral walls 124 form an outer shell of the shoe 10, and are configured to be glued and nailed directly to the horse hoof. Further, a caudal support 184 can be provided to interconnect the interior of the shoe 10.

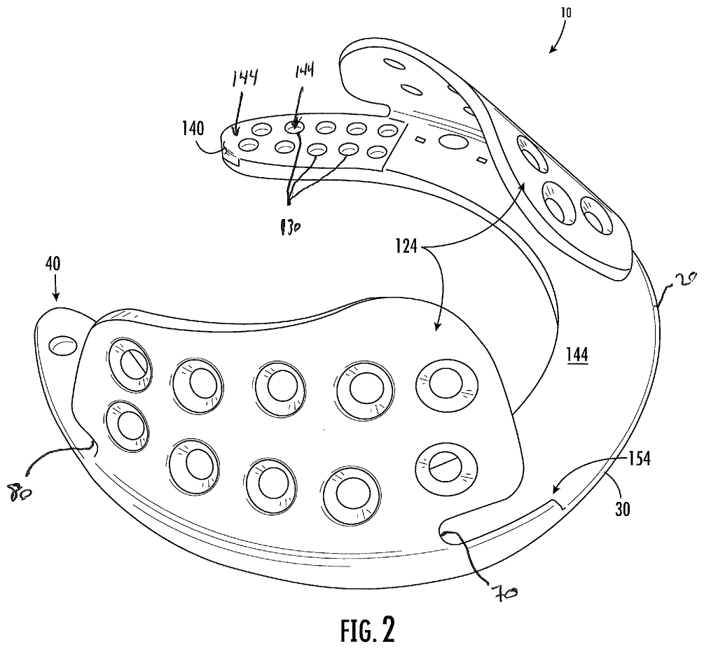

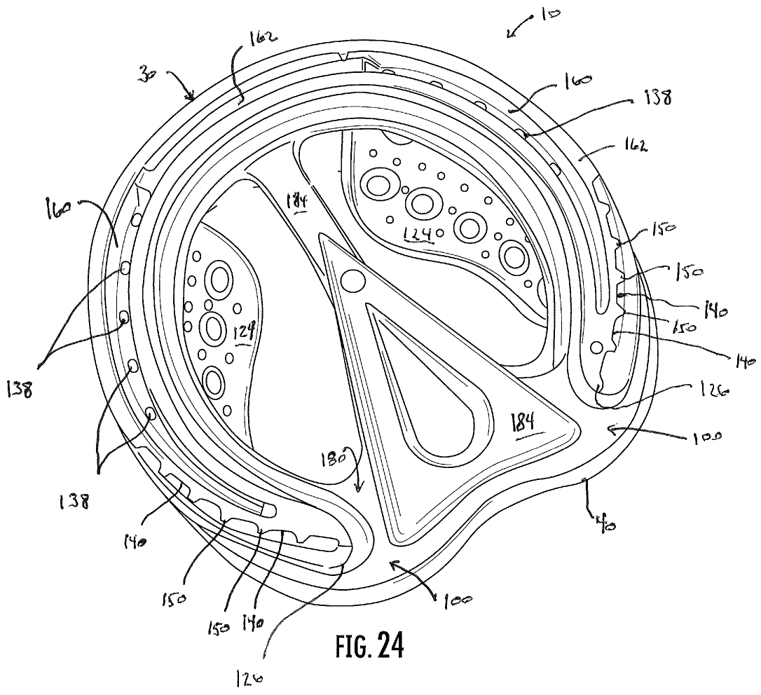

Shoe 126 forms the rigid base of shoe 10. To manufacture shoe 10, shoe 126 can be created from a metal aluminum blank machined into the configuration of FIGS. 2-16, or FIGS. 24-29. Alternatively, other types of metal can be used, including magnesium, copper, titanium, or steel. For example a metal shoe 126 can be machined with a properly configured CNC machine. In another embodiment, shoe 126 can be made of a highly rigid polymer instead of metal.

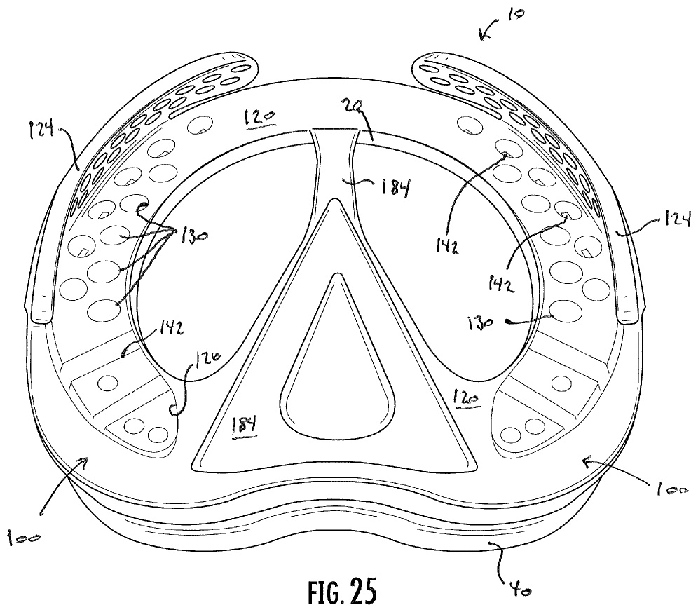

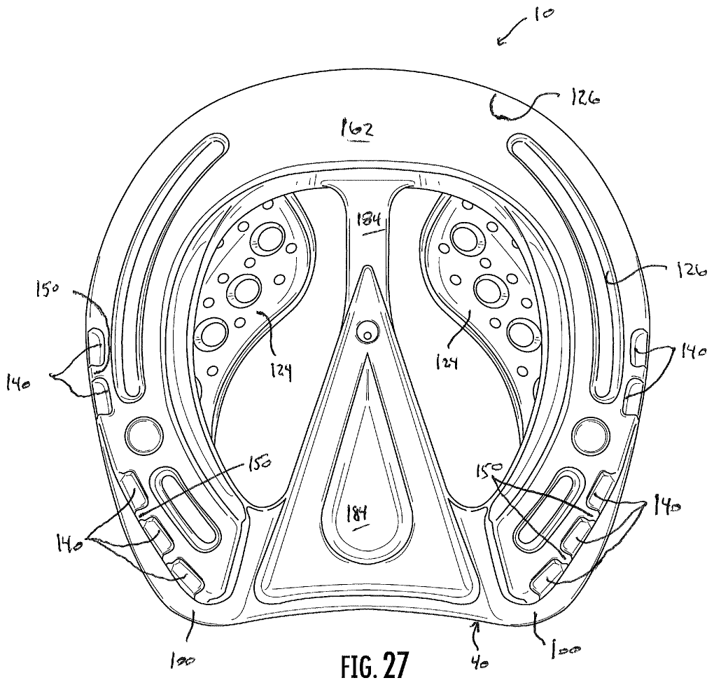

Metal shoe 126 includes cavities 130 sufficiently large to permit complete penetration of urethane during the overmolding process, while maintaining sufficient material to support the loads and impacts experienced by a horse during daily activities. Fenestrations 140 are likewise sufficiently large to permit penetration of urethane through each fenestration and passageways 142 during the overmolding process. Further, as depicted in FIGS. 24 and 27, the fenestrations 140 can be recessed, thus forming lateral ridges 150 on shoe 126. Additionally, passageways 142 can be provided as channels, as depicted in FIG. 25. Upon completion of the metal shoe, using an overmolding process, the urethane upper portion is melded into cavities 130, fenestrations 140, and passageways 142, thus forming a firm, secure and durable attachment between polymer upper 120 and metal shoe 126. Once overmolding of the upper portion and shoe 126 is complete, shoe 126 has a polymer surface 144 that covers a substantial portion or the entirety of superior end 170 of shoe 10, as shown in FIG. 1. Likewise, once overmoldeding of the upper portion and shoe 126 is complete, shoe 126 has a polymer surface 144 that covers a substantial portion of or the entirety of inferior end 180 of shoe 10, as shown in FIG. 24.

Polymer upper 120 is preferably formed from a polymer such as urethane. In one preferred embodiment, the urethane polymer is of a relatively rigid durometer or hardness. Preferably, the shoe is formed from a urethane having a durometer between 80 A and 90 A. However, other polymers, such as plastics and rubbers, as well as materials having similar durometers, can be used. As shown in the figures, polymer upper is made of a translucent urethane, depicted as polymer surface 144. As such, metal shoe 126 is partly visible through the urethane material. For this reason, shoe 126 is identified in numerous figures, see, e.g., FIGS. 24-28, even when shoe 126 is covered in whole or in part by the overmolded polymer upper 120. This is best shown in FIGS. 1-6 of U.S. Provisional Application No. 63/462,458, which are photographs that fully illustrate the contrast between upper 120 and shoe 126.

Lateral walls 124 are provided with distal cutouts 70 and a proximal cutout 80. Such cutouts substantially improve the fit, adherence and durability of shoe 10 to the horse hoof. In particular, proximal cutout 80 improves adherence to a horse hoof by increasing the surface area adhered to the hoof, while permitting additional hoof and shoe flexion without breaking the adhesive bond. Likewise, distal cutout 70 improves adherence to a horse hoof by increasing the surface area adhered to the hoof, while permitting additional hoof and shoe flexion without breaking the adhesive bond. Thus, when in use, distal cutout 70 and a proximal cutout 80 allow for expansion and contraction, as well as permitting growth of, the horse hoof without compromising fit and adhesion of the shoe.

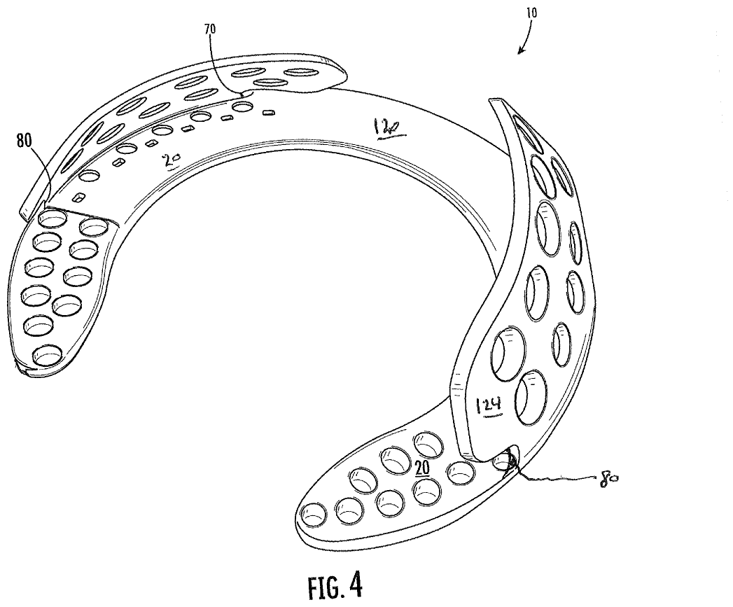

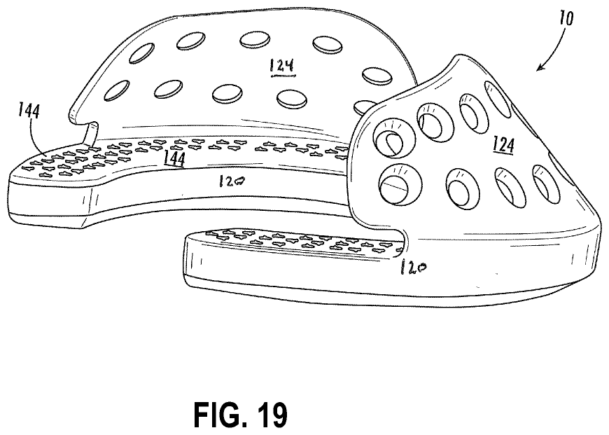

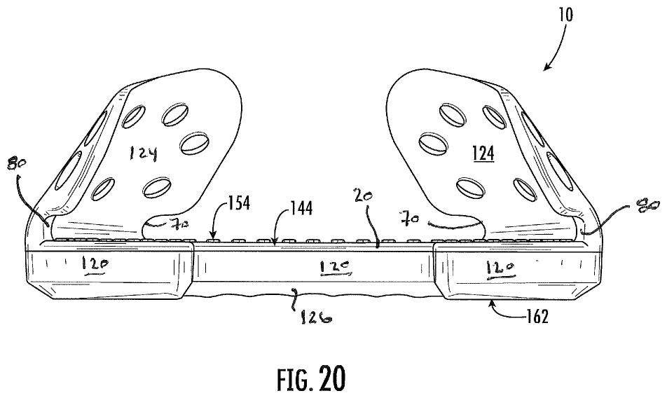

Platform 20 has a distal end 30 and a proximal end 40, as well as an upper surface 154, as depicted in FIGS. 1 and 20, for example. The upper surface 154 is shaped to receive a horse hoof. Moreover, as shown in FIGS. 19 and 20, to improve hoof traction on platform 20, upper surface 154 of the platform can be provided with a textured surface. Bottom 162 is provided with treads 160 to improve traction in use. Distal end 30 is shaped to receive the toe of a horse hoof. Proximal end 40 is sized to receive the heel of a horse hoof. As shown in FIG. 4, the interior of the platform 20 is generally formed in the shape of a segmented arc to comfortably accommodate and support the frog of the horse hoof. The quarters of the horse hoof is sized to fit between the proximal cutouts 80 and adjacent to the lateral walls 50.

In other embodiments, illustrated in FIGS. 24-29, the interior of platform 20 has a caudal support 184. Caudal support 184 is urethane that provides both support and added protection to the soft tissues of the hoof, while improving the structural integrity of shoe 10. Further, as illustrated in FIGS. 24-28, platform 20 includes an enlarged heel region 100. Heel region 100 permits a user to more closely shape the platform to conform to the hoof, thus improving fit while maximizing the amount of material that can be worn out during use for the unique anatomy of each animal. A farrier can remove material from section 100 by using a rasp or nippers during the fitting process.

Raised lateral walls 124 can be made of a flexible material such as urethane. In another embodiment the platform 20 and the lateral wall or cuffs 124 are formed as a uniform structure. In one embodiment the lateral raised lateral wall 124 and the platform 20 are provided as an integral shoe having a urethane upper overmolded onto a metal shoe having lateral fenestrations and cavities. In general, the lateral walls include proximal and distal curvilinear recesses, which are depicted as cutouts 70 and 80. In one embodiment, the lateral wall includes several openings or circular holes 90. Optionally, circular holes 90 can be utilized as holes for nails. The nails can be used to secure the lateral raised lateral wall 124 to the horse hoof. In one embodiment a glue such as cyanoacrylate is used to securely adhere lateral walls 124 to the hoof wall of the horse.

As noted above, as illustrated in FIGS. 24-28, the proximal end 40 of the shoe 10 is provided with an enlarged heel region 100 made of a material that can be shaved, rasped or nipped, such as urethane. This permits a user to precisely shape platform 20 to conform to the size and shape of the horse heel. The more precise proximal fit reduces the likelihood of the shoes interfering with a horse's gallop or other movement.

To fit the shoes 10, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods. For example, to ensure proper adhesion, the hoof can be roughed using a rasp or other appropriate tool and cleaned of dust, preferably three times.

An adhesive is then applied to the interior of lateral walls 124, as well as the horse hoof. The shoe is then pressed onto the hoof and wrapped with plastic wrap until an adhesive bond is formed, at which time the plastic wrap can be removed. Once adhered to the hoof, the shoe can be nailed to the hoof through nail holes 138, and the proximal end of the platform can be shaved into a shape that corresponds with the actual anatomy of the horse hoof. Alternatively, a farrier can shave or nip the platform (including heel region 100) prior to adhering cuffs 124 to the hoof wall. The process is repeated for each hoof.

In one preferred embodiment, a kit is provided for the field attachment of a pre-sized horse shoe. For example, such a kit includes one or more pre-sized horse shoes, such as illustrated in FIG. 1. It also includes a packet, bottle or tube of an adhesive such as cyanoacrylate having sufficient adhesive to attach each horse shoe in the kit. Additionally, the kit is provided with a plastic wrap for temporarily securing the horse shoe while the adhesive cures. Optionally, the kit can be provided with a sufficient number of nails to nail the shoes to the horse hoof.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

1. An equine shoe comprising:
a polymer upper forming a segmented arc; the upper having a top, a bottom, a proximal end, a distal end, and an outer periphery; a cuff extending from the outer periphery;
a metal lower forming a segmented arc, the metal lower having a plurality of fenestrations and cavities, wherein the polymer upper is overmolded to the metal lower.

2. The equine shoe of claim 1, wherein the cuff includes a distal cutout.

3. The equine shoe of claim 1, wherein the cuff includes a proximal cutout.

4. The equine shoe of claim 1, where in the cuff includes a distal cutout and a proximal cutout.

5. The equine shoe of claim 4, wherein the polymer upper is urethane.

6. The equine shoe of claim 5, wherein the metal lower includes a top surface in communication with the polymer upper, and a treaded surface, wherein the treaded surface is configured to provide traction.

7. The equine shoe of claim 6, wherein the top surface is textured.

8. The equine shoe of claim 6, wherein the cuff includes a plurality of openings.

9. An equine shoe comprising:
a polymer upper portion forming a segmented arc defining an inner periphery and an outer periphery;
a first cuff extending from the outer periphery, the first cuff defining a distal cutout and a proximal cutout;
a metal lower portion, the lower portion comprising a fenestration, a cavity and a passageway between the fenestration and the cavity, and a treaded surface;
a portion of the polymer upper being disposed through each of the cavity and fenestration, wherein the upper is permanently secured to the lower portion.

10. The equine shoe of claim 9, wherein the metal is aluminum.

11. The equine shoe of claim 9, wherein the metal is steel.

12. The equine shoe of claim 9, wherein the metal is titanium.

13. The equine shoe of claim 9, wherein the metal is magnesium.

14. The equine shoe of claim 9, wherein the metal is copper.

15. The equine shoe of claim 9, further comprising a second cuff, the second cuff extending from the outer periphery and defining a second distal cutout and a second proximal cutout.

16. An equine shoe attachment kit having component parts capable of being assembled in the field, the kit comprising a combination of:
the equine shoe of claim 1; and
a tube of cyanoacrylate adhesive.

17. The equine shoe attachment kit of claim 16 further comprising a plastic wrap for temporarily securing the equine shoe to an equine shoe.

18. The equine shoe attachment kit of claim 17 further comprising a plurality of nails for nailing the metal lower to a horse hoof.

19. An equine shoe comprising: a metal horse shoe having a top, a bottom, and an intermediate portion therebetween; a plurality of cavities extending through the top;
and a plurality of fenestrations extending through the intermediate portion; wherein at least one passageway connects a cavity to a fenestration.

20. The shoe of claim 19, further comprising a treaded surface on the bottom.

21. The shoe of claim 20, further comprising a polymer upper overmolded to the top.

22. The shoe of claim 21, further comprising a first cuff attached to the upper.

23. The shoe of claim 22, further comprising a second cuff attached to the upper.

24. The shoe of claim 23, wherein the first and second cuffs include a cutout.

25. The shoe of claim 23, wherein the polymer upper is a urethane having a durometer between 80 A and 90 A.
